(19) United States
(12) Patent Application Publication
(10) Pub. No.: US 2024/0169425 A1
(43) Pub. Date: May 23, 2024

(54) COMPUTER-IMPLEMENTED PROCESS FOR GROUP-BASED MATCH OPTIMIZATION

(71) Applicant: Blue Lakes Technology Inc., Redondo Beach, CA (US)

(72) Inventor: Anand Menon, Redondo Beach, CA (US)

(73) Assignee: Blue Lakes Technology Inc., Redondo Beach, CA (US)

(21) Appl. No.: 17/989,563

(22) Filed: Nov. 17, 2022

(51) Int. Cl. G06Q 40/03; G06Q 30/0201; G06Q 40/02

(52) U.S. Cl. CPC G06Q 40/03; G06Q 30/0201; G06Q 40/02

(57) ABSTRACT

A computer-implemented method is provided to optimize a group-based match via a probabilistic engine through a computerized network. The computer-implemented method stores, in a borrower database, a plurality of borrower data sets. Each of the plurality of borrower data sets corresponds to one or more predefined borrower requirements for each borrower corresponding to each of the plurality of borrower data sets. Further, the computer-implemented method receives, in a product database at a product entry time, product information for a financial product. The financial product is distinct from other products having other product information stored within the product database. Additionally, the computer-implemented queries, with a group-based matching engine in real-time with the receipt of the product information at the product entry time, a subset of the plurality of borrower data sets with the one or more predefined borrower requirements that are capable of being fulfilled by the financial product.

### BACKGROUND

### 1. Field

This disclosure generally relates to computing systems. More particularly, the disclosure relates to financial computing systems.

### 2. General Background

An Internet-centric problem facing technological infrastructure within the financial services industry is that conventional computing systems are incapable of being used to originate and complete the sale of various financial products, such as, for example, mortgage refinance products, in a computationally efficient and accurate manner. For instance, these systems oftentimes require users to perform manual online searches for such products, when rapidly changing fluctuations (e.g., daily changes in interest rates) make finding the optimal product impractical for a user.

Similarly, such systems require lenders to send emails, make phone calls, or the like to find customers for newer products. In fact, bankers may spend a large portion of their time in pursuing such outreach efforts. Accordingly, each time a new financial product is deployed, lenders incur substantial time, cost, and expense.

To summarize, conventionally, the Internet allows users to perform online searches for financial products, and bankers to communicate with potential customers regarding such financial products. The net effect of such inefficient use of resources (i.e., computing resources, human resources, etc.) is an increased cost of the financial product that is passed on to users.

### SUMMARY

A computer-implemented method is provided to optimize a group-based match via a probabilistic engine through a computerized network. The computer-implemented method stores, in a borrower database, a plurality of borrower data sets. Each of the plurality of borrower data sets corresponds to one or more predefined borrower requirements for each borrower corresponding to each of the plurality of borrower data sets. Further, the computer-implemented method receives, in a product database at a product entry time, product information for a financial product. The financial product is distinct from other products having other product information stored within the product database. Additionally, the computer-implemented queries, with a group-based matching engine in real-time with the receipt of the product information at the product entry time, the borrower database to determine a subset of the plurality of borrower data sets with the one or more predefined borrower requirements that are capable of being fulfilled by the financial product. Moreover, the computer-implemented method classifies, with a classification engine, the subset of the plurality of borrower data sets into a plurality of groups based on a plurality of financial product attributes. For each of the plurality of groups, the computer-implemented method determines, via a probabilistic engine, a corresponding candidate group that has a probabilistic score that meets a probabilistic threshold indicative of a likelihood of members of the candidate group purchasing the financial product. Furthermore, for each of the plurality of groups, the computer-implemented method determines, via a group discount engine that communicates with one or more lender computing systems through the computerized network, a group quantity discount to be applied to the financial product based on a predetermined group quantity threshold specific to each of the plurality of groups being met.

As an alternative, a computer program product may have a computer readable storage device with a computer readable program stored thereon that implements the computer-implemented method. As yet another alternative, a computerized system may be utilized to implemented the computer-implemented method.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a group-based matching configuration that provides Internet-centric optimization, vi a computerized network, for matching products and users.

Turning to FIG. 2, the probabilistic engine utilizes various configurable weighted attributes to train an artificial intelligence (“AI”) engine to determine the probabilistic score.

FIG. 3 illustrates the interactions between the group discount engine 107 and each of the lender computing systems 109a-109c.

FIG. 4 illustrates an example of groups generated from the computer-implemented method.

FIG. 5A illustrates the weighting data structure storing user information data.

FIG. 5B illustrates the weighting data structure storing a probabilistic tabulation and probabilistic score.

FIG. 6 illustrates the computer-implemented method of optimizing a group-based match via the probabilistic engine through the computerized network.

FIG. 7 illustrates a system configuration that implements the group-based matching configuration illustrated in FIG. 1.

### DETAILED DESCRIPTION

A computer-implemented method optimizes group-based matches between a financial product and a group of users. In contrast with conventional Internet-centric approaches, the computer-implemented method automatically performs self-executing group-based matching based on predetermined attributes—from both users and lenders. Users no longer have to perform manual Internet-based searches for financial products, and lenders no longer have to expend computing and human resources on extensive Internet-based communications with potential customers. The participants may utilize the computer-implemented method to predetermine/preconfigure configurable attributes that are then used to optimize matches and determine groups of users for the purpose of collectively bargaining a group discount via such predetermined attributes. With this Internet-centric solution, the quantity of matching users for a given product are counted, thereby allowing for a real-time (i.e., measured as an imperceptible delay), or a substantially real-time (i.e., measured as a perceptible, yet insignificant delay), determination of a match between a group of users and financial product as well as a group discount. Given that the configurable parameters are predetermined/preconfigured, the group discount is triggered on the fly (without having to perform subsequent negotiations) upon introduction of a new financial product. This allows for real-time matching and group-discount application via a computerized network configuration that could not be performed via conventional technological infrastructure. As a result of the real-time or substantial real-time Internet-centric solution, users are able to avoid missing opportunities in rapidly fluctuating financial environments, and lenders are able to avoid missing willing and able consumers for their financial products.

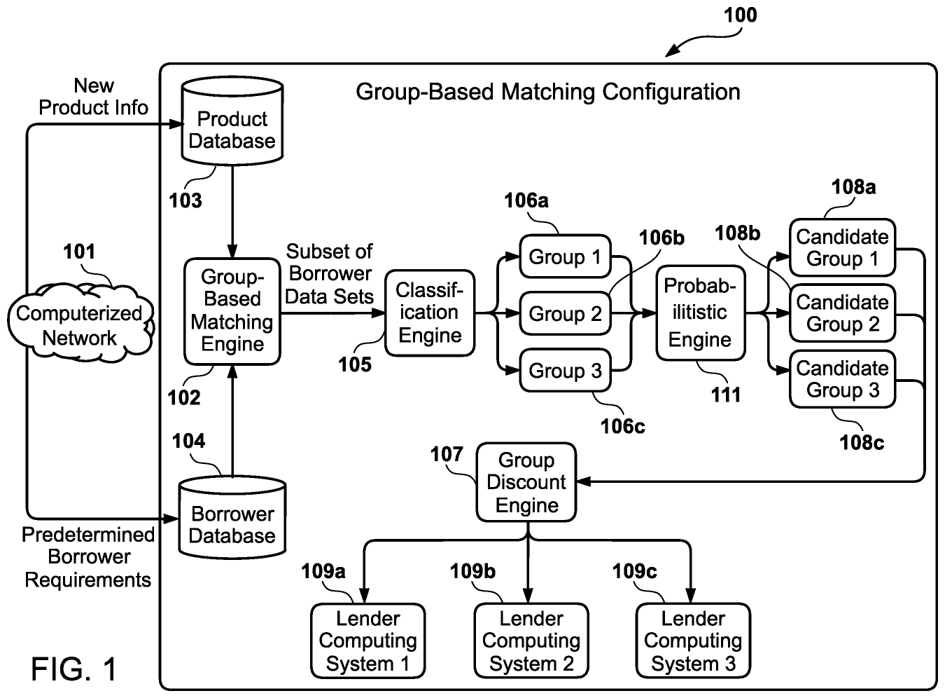

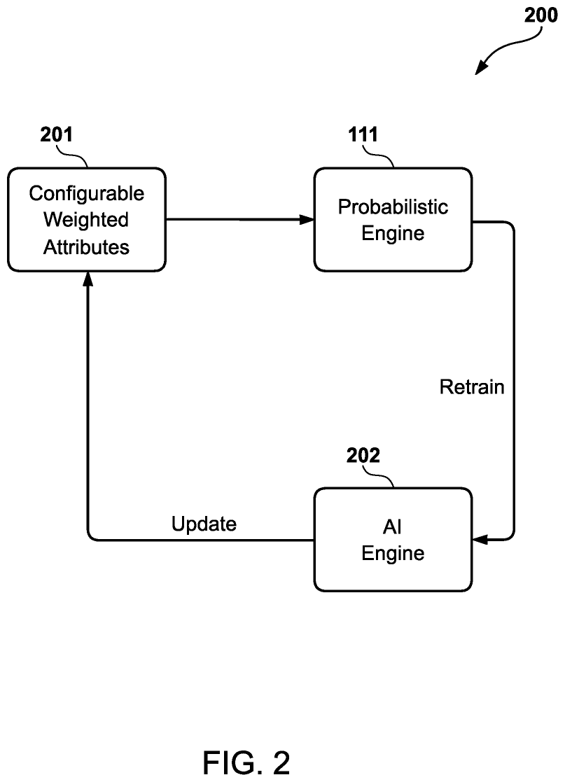

FIG. 1 illustrates a group-based matching configuration 100 that provides Internet-centric optimization, vi a computerized network 101, for matching products and users. In particular, the group-based matching configuration 100 has a borrower database 103 and a product database 104. The borrower database 103 stores a plurality of borrower data sets, each of which corresponds to one or more predefined borrower requirements for each borrower (user) corresponding to each of the plurality of borrower data sets. Furthermore, the product database 104 stores product information for a financial product. An example of a financial product is a mortgage refinance product. (Other types of financial products may be utilized.)

The group-based matching configuration 100 also has a group-based matching engine 102. Upon receipt of a new financial product by the product database 104, the group-based matching engine 102 is automatically triggered to query the borrower database 103 to determine a subset of the plurality of borrower data sets with the one or more predefined borrower requirements that are capable of being fulfilled by the financial product. The new financial product, distinct from other financial products stored in the product database 104, is received at a product entry time, which may be recorded via a digital timestamp. In real-time or substantial real-time with the product entry time, the group-based matching engine 102 performs the query.

The results of the query are then provided to a classification engine 105, which classifies the subset of the plurality of borrower data sets into a plurality of groups (e.g., a first group 106a, a second group 106b, and a third group 106c) based on a plurality of financial product attributes. (Three groups are illustrated as examples only. More or less groups may be utilized.) As an example, the plurality of groups may consist of a loan amount group, a credit score group, and a loan to value group. (Other types of groups may be utilized instead.)

These groups may be provided to a probabilistic engine 106 that determines the probability of each of the groups purchasing the financial product. For instance, the probabilistic engine 106 may determine a probabilistic score. Turning to FIG. 2, the probabilistic engine 106 utilizes various configurable weighted attributes to train an AI engine 202 to determine the probabilistic score. Subsequent to each candidate group being determined, the probabilistic engine 106 may retrain the AI engine 202 to improve accuracy. The configurable weighted attributes may be used to weigh certain attributes more than others when determining the probabilistic score. For example, a historical quantity of refinances performed via the corresponding software application may have a weighting factor of ten (being the highest weighting) as opposed to the historical quantity of refinances performed without the corresponding software application having a weighting factor of three (being a lower weighting). Accordingly, in one embodiment, the weighting factor is configured in favor of factors that encourage usage of the software application corresponding to the group-based matching configuration 100. In another embodiment, the probabilistic engine 106 trains the AI engine 202 to adaptively configure the weighting factors based on historical analysis of which factors are most indicative of a purchase of the financial product. Accordingly, the probabilistic engine 106 may executed a perpetual feedback loop that continuously retrains the AI engine 202 and reconfigures the configurable weighted attributes to improve optimization of group-matching for the financial product.

In another embodiment, the AI engine 202 is trained to adjust the weighting factors themselves. In other words, the AI engine 202 learns what weighting factors are most conducive to generating successful purchases of the financial product. For example, the AI engine 202 may learn to adapt the weighting for income to be higher than the weighting for the number of times a user had previously purchased a financial product. (This is just one example. Various other weighting adjustments may be performed by the AI engine 202.) Accordingly, the computer-implemented method provides a technological solution to automatically adjust weighing factors via the AI engine 202.

Returning to FIG. 1, for each of the plurality of groups 106a-106c, the probabilistic engine 106 determines a corresponding candidate group that has a probabilistic score that meets a probabilistic threshold indicative of a likelihood of members of the candidate group purchasing the financial product. In one embodiment, the probabilistic threshold is predetermined. In another embodiment, the probabilistic threshold is adaptively configured based on historical analysis to improve optimization. For example, the probabilistic threshold may adapt from eight to percent to ninety percent.

As a result of the determination by the probabilistic engine 106, a plurality of candidate groups 108a-108c are outputted to a group discount engine 107. (Three candidate groups are illustrated only as an example. More or less candidate groups may be outputted.) In one embodiment, the probabilistic threshold is determined per candidate group.

The groups discount engine 107 may communicate with a plurality of lending computing systems 109a-109c. (Three lending computing systems are illustrated only as an example. More or less lending computing systems may be utilized.)

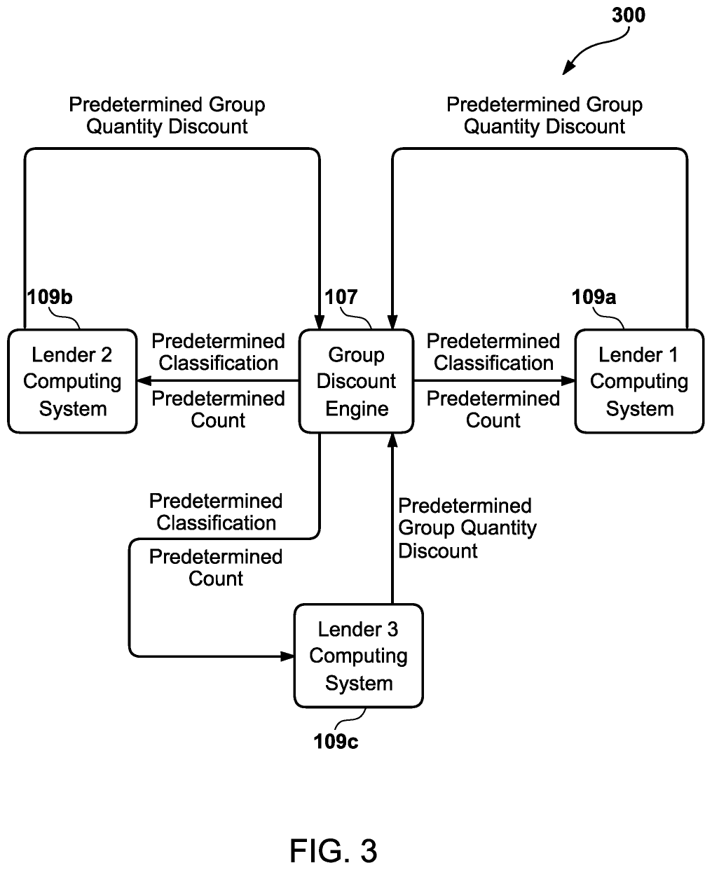

FIG. 3 illustrates the interactions between the group discount engine 107 and each of the lender computing systems 109a-109c. By way of example with reference to the first lender computing system 109a, the group discount engine provides the predetermined classification and predetermined quantity of members of the group to the first lender computing system 109a before the product entry time of the new financial product into the product database 103. In essence, a self-executing, automated collective bargaining process is implemented to predictively determine how the lending computing system 109a would negotiate the price of the financial product based on the quantity of members in the group. Various factors, including but not limited to cost savings resulting from reduced overhead related to customer outreach, may contribute to the size of the group discount. An example of another factor is the profit margin realized form use of the group discount as opposed to the profit margin realized from individuals sales of the financial product.

In one embodiment, the group discount engine 107 may perform a self-executing, iterative negotiation process with each of the lending computing systems 109a-109c until a group quantity discount threshold is within a predetermined tolerance. For example, the group discount engine 107 may determine that the group quantity discount should be thirty percent, whereas the lending computing system 109a may indicate twenty-nine percent, which may within an acceptable tolerance of two percent. Furthermore, the iterative negotiation process may learn, via the AI engine 202, from historical analysis via the corresponding software application which group discounts are most optimal for different quantities of users.

From product entry to group discount determination, the user and the lenders may perceive real-time or substantially real-time processing. Accordingly, users and lenders should be instantly aware of matches. Because the negotiations are predetermined in a predictive manner, various parameters are predetermined, and therefore devoid of the need for calculation after product entry; the result being further reduction in processing time after product entry. In essence, what could have been inefficiently performed during post-processing is shifting to a pre-processing stage to improve processing speed, and thereby enhance the real-time or substantial real-time aspects of the computer-implemented method.

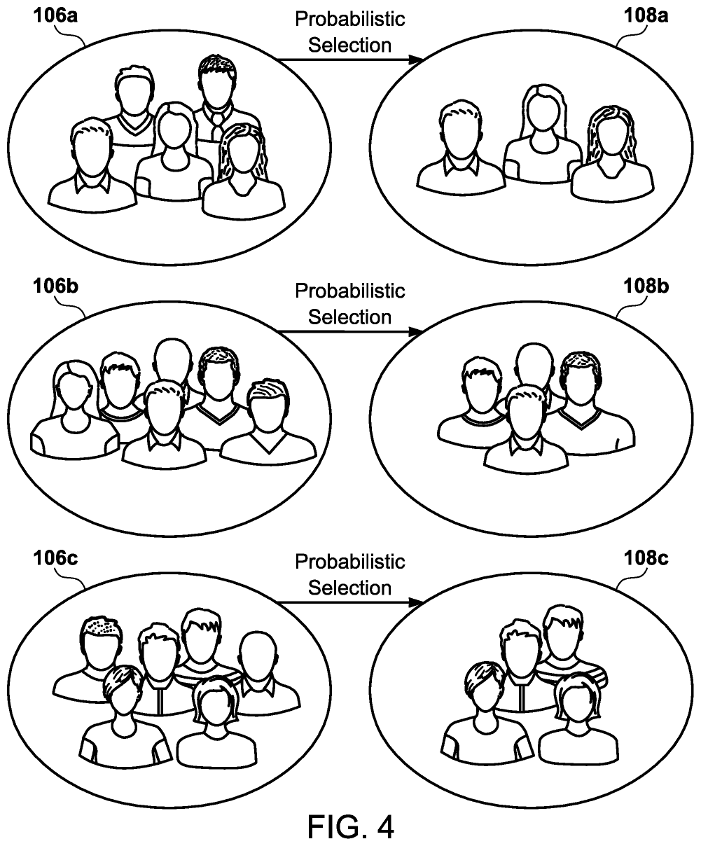

FIG. 4 illustrates an example of groups generated from the computer-implemented method. For example, groups 106a-106c are illustrated with users that are categorized according to the groups. In one embodiment, overlap is permitted between the different groups. For example, a user with a high credit score and also a high loan to value mortgage may be present into two groups. Subsequent to probabilistic selection, the candidate groups 108a-108c are selected from the groups 106a-106c.

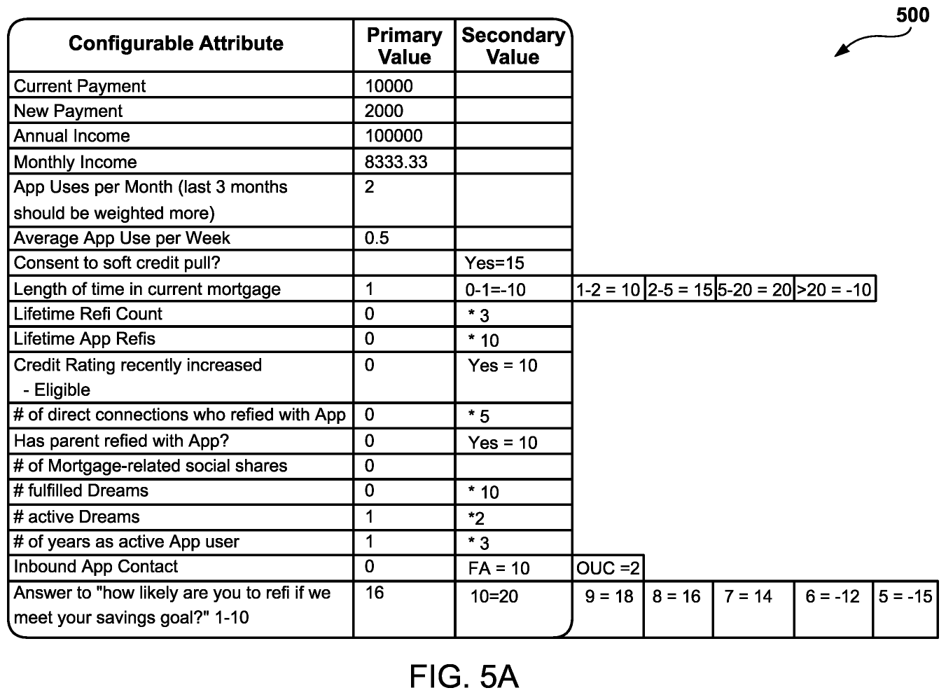

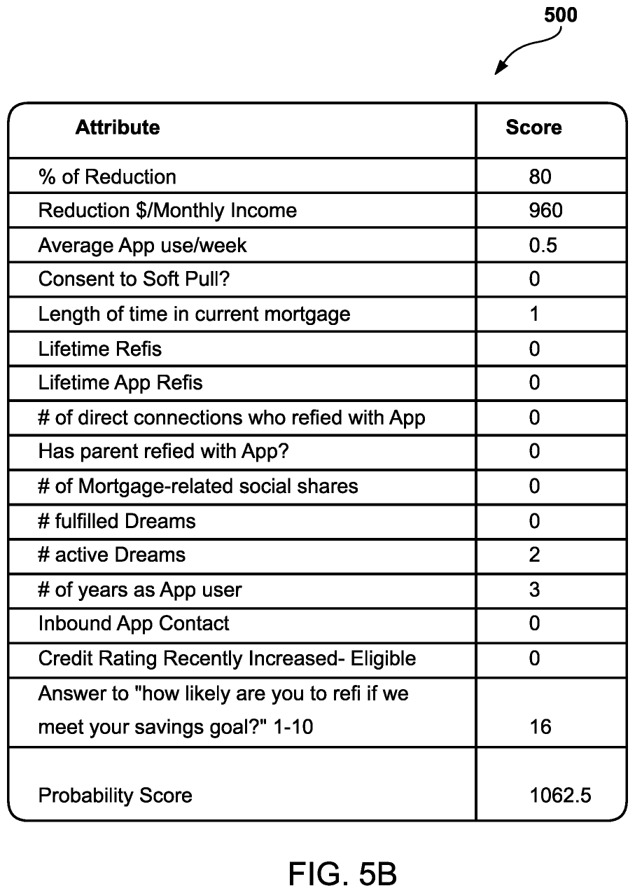

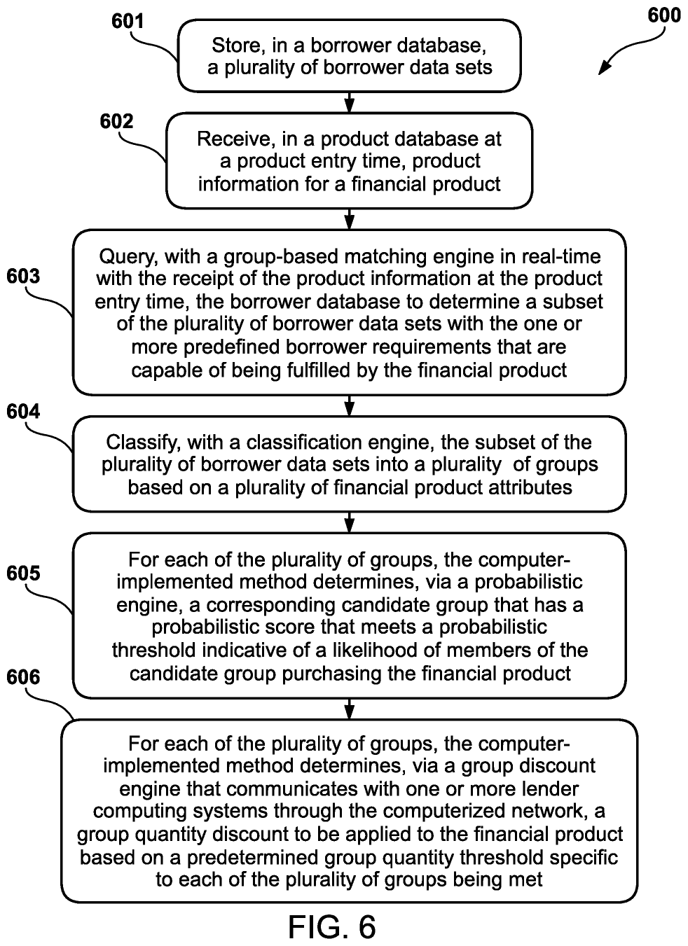

FIGS. 5A-5B illustrate an example of a weighting data structure 500 that is utilized by the computer-implemented method illustrated in FIG. 6 to apply and adjust weights for configurable attributes, and to calculate a probabilistic score via the weights. The weighted data structure may be an array, linked list, or the like that stores both the configurable attribute and a corresponding weighting factor in a manner in which the configurable attribute is coupled to the weighting factor. In particular, FIG. 5A illustrates the weighting data structure 500 storing user information data, such as current payment, new payment, annual income, monthly income, application uses, average application use per week, consent to soft credit pull, length of time in current mortgage, lifetime refinance account, lifetime application refinances, increase in credit rating, quantity of direct connections who refinanced via the software application, whether a parent has refinanced with the software application, quantity of mortgage-related social shares, quantity of fulfilled dreams via the software application, quantity of active dreams via the software application, number of years as an active application user, inbound software application contact (financial advisor (“FA”) or other unique contact (“OUC”)), and savings goal. With respect to some, but not necessarily all, of the weighted data structure components, a secondary value (the weighting) is stored with the primary value (the answer to the question being posed). For instance, the secondary value for lifetime software applications may be a weighting of ten, whereas the secondary value for lifetime refinances may be a weighting of three; thereby, incentivizing use of the software application. Additionally, the secondary value may itself may a data structure. As an example, the secondary value may be an array (i.e., an array within an array). FIG. 5A illustrates the foregoing: the secondary value for the length of time in the current mortgage is a secondary array of values (e.g., negative ten for zero to one years, ten for one to two years, fifteen for two to five years, twenty for five to twenty years, and negative ten for greater than twenty years.) As another example (partially illustrated in FIG. 5A), the savings goal may be scored on a scale of one to ten (e.g., a goal of ten equaling a score of twenty, a goal of nine equaling a score of eighteen, a goal of eight equaling a score of sixteen, a goal of seven equaling a goal of fourteen, a goal of six equaling a score of negative twelve, a goal of five equaling a score of negative fifteen, a goal of four equaling a score of negative twenty, a goal of three equaling a score of negative thirty, a goal of two equaling a score of negative fifty, and a goal of one equaling a score of negative one hundred.) (The specific values described herein are intended only as examples.)

FIG. 5B illustrates the weighting data structure 500 storing a probabilistic tabulation and probabilistic score. For example, the weighting data structure 500 may store various attributes such as percentage of reduction in current payment, reduction in payment, average application user per week, consent to soft credit pull, length of time in current mortgage, lifetime refinances, lifetime software refinances, parent refinance with software application, number of mortgage-related social shares, number of fulfilled dreams, number of active dreams, number of years as a software application user, inbound contact for software application, eligibility, and meeting the savings goal. A probabilistic score is then calculate based on the sum of the different foregoing, individual scores.

FIG. 6 illustrates the computer-implemented method 600 of optimizing a group-based match via the probabilistic engine 111 through the computerized network 101. At a process block 601, the computer-implemented method 600 stores, in a borrower database, a plurality of borrower data sets. Each of the plurality of borrower data sets corresponds to one or more predefined borrower requirements for each borrower corresponding to each of the plurality of borrower data sets. Further, at a process block 602, the computer-implemented method receives, in a product database at a product entry time, product information for a financial product. The financial product is distinct from other products having other product information stored within the product database. Additionally, at a process block 603, the computer-implemented queries, with a group-based matching engine in real-time with the receipt of the product information at the product entry time, the borrower database to determine a subset of the plurality of borrower data sets with the one or more predefined borrower requirements that are capable of being fulfilled by the financial product. Moreover, at a process block 604, the computer-implemented method classifies, with a classification engine, the subset of the plurality of borrower data sets into a plurality of groups based on a plurality of financial product attributes. At a process block 605, for each of the plurality of groups, the computer-implemented method determines, via a probabilistic engine 111, a corresponding candidate group that has a probabilistic score that meets a probabilistic threshold indicative of a likelihood of members of the candidate group purchasing the financial product. Furthermore, at a process block 606, for each of the plurality of groups, the computer-implemented method determines, via a group discount engine that communicates with one or more lender computing systems through the computerized network, a group quantity discount to be applied to the financial product based on a predetermined group quantity threshold specific to each of the plurality of groups being met.

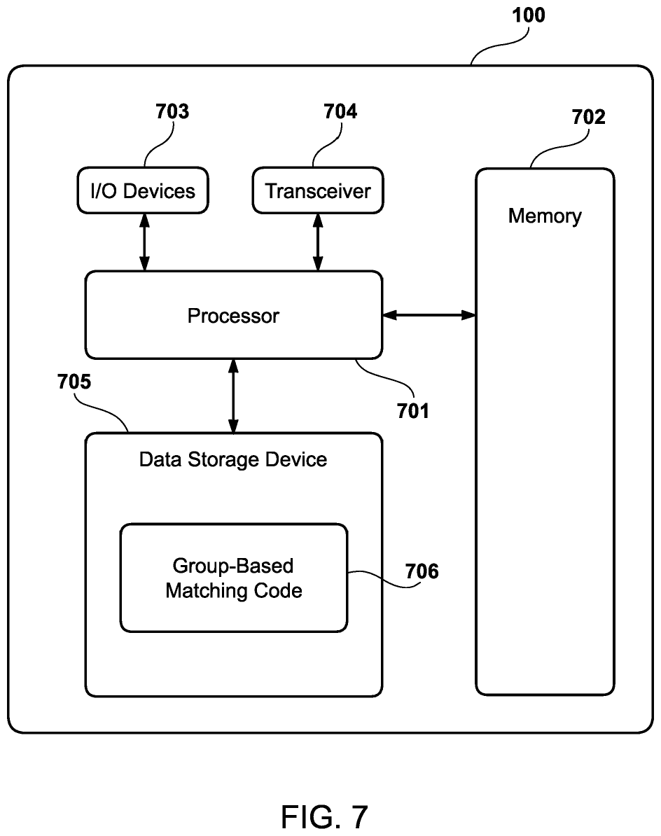

FIG. 7 illustrates a system configuration that implements the group-based matching configuration 100 illustrated in FIG. 1. In particular, a processor 701, which may be specialized real-time or substantial real-time communications, may be used to perform the operations illustrated in FIG. 1. Furthermore, a memory device 702 may store interface data, or portions thereof, for processing by the processor 701. The memory device 702 may also store computer readable instructions performed by the processor 701. As an example of such computer readable instructions, a data storage device 705 within the system configuration may store group-based matching code 706.

Moreover, the system configuration may have one or more input/output (“I/O”) devices 703 that may receive inputs and provide outputs. Various devices (e.g., keyboard, microphone, mouse, pointing device, hand controller, etc.) may be used for the I/O devices 703. The system configuration may also have a transceiver 704 to send and receive data. Alternatively, a separate transmitter and receiver may be used instead.

Furthermore, various illustrations have depicted computing devices such as mobile computing devices and desktop computers. However, the configurations provided for herein may be implemented via other types of computing devices (e.g., laptops, tablet devices, smartwatches, etc.). A computer is intended herein to include any device that has a specialized processor as described above. For example, a computer may be a personal computer (“PC”), laptop computer, set top box, cell phone, smartphone, tablet device, smart wearable device, portable media player, video player, etc.

It is understood that the apparatuses, systems, computer program products, and processes described herein may also be applied in other types of apparatuses, systems, computer program products, and processes. Those skilled in the art will appreciate that the various adaptations and modifications of the embodiments of the apparatuses described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

I claim:

1. A computer-implemented method of optimizing a group-based match via a probabilistic engine through a computerized network, comprising:
storing, in a borrower database, a plurality of borrower data sets, wherein each of the plurality of borrower data sets corresponds to one or more predefined borrower requirements for each borrower corresponding to each of the plurality of borrower data sets;
receiving, in a product database at a product entry time, product information for a financial product, the financial product being distinct from other products having other product information stored within the product database;
querying, with a group-based matching engine in real-time with the receipt of the product information at the product entry time, the borrower database to determine a subset of the plurality of borrower data sets with the one or more predefined borrower requirements that are capable of being fulfilled by the financial product;
classifying, with a classification engine, the subset of the plurality of borrower data sets into a plurality of groups based on a plurality of financial product attributes;
for each of the plurality of groups, determine, via a probabilistic engine, a corresponding candidate group that has a probabilistic score that meets a probabilistic threshold indicative of a likelihood of members of the candidate group purchasing the financial product;
for each of the plurality of groups, determine, via a group discount engine that communicates with one or more lender computing systems through the computerized network, a group quantity discount to be applied to the financial product based on a predetermined group quantity threshold specific to each of the plurality of groups being met.

2. The computer-implemented method of claim 1, wherein the probabilistic engine determines the probabilistic score, via an artificial intelligence engine, according to one or more configurable weighted attributes.

3. The computer-implemented method of claim 2, wherein the probabilistic engine retrains the artificial intelligence engine to update the configurable weighted attributes subsequent to each candidate group being determined.

4. The computer-implemented method of claim 1, wherein the plurality of groups consists of: a loan amount group, a credit score group, and a loan to value group.

5. The computer-implemented method of claim 1, further comprising transmitting a predetermined classification and a predetermined group quantity to the one or more lender computing systems prior to the querying.

6. The computer-implemented method of claim 5, further comprising receiving the predetermined group quantity threshold from the one or more lender computing systems based upon a calculation of that uses the predetermined classification and the predetermined group quantity.

7. The computer-implemented method of claim 6, wherein the calculation automatically determines a profit margin to be realized via application of the group quantity discount in comparison to a profit margin to be realized for individualized sales of the financial product.

8. The computer-implemented method of claim 7, further comprising performing the calculation.

9. The computer-implemented method of claim 7, wherein the one or more lender computing systems perform the calculation.

10. The computer-implemented method of claim 7, further comprising automatically performing a self-executing, iterative negotiation between with the one or more lender computing systems until the group quantity discount threshold is within a predetermined tolerance.

11. The computer-implemented method of claim 1, wherein the financial product is a mortgage refinance product.

12. A computer program product comprising a non-transitory computer-readable storage device having computer coded embodied therein, which, when executed on a computing device causes the computing device to generate a computerized user interface that is configured to:
store, in a borrower database, a plurality of borrower data sets, wherein each of the plurality of borrower data sets corresponds to one or more predefined borrower requirements for each borrower corresponding to each of the plurality of borrower data sets;
receive, in a product database at a product entry time, product information for a financial product, the financial product being distinct from other products having other product information stored within the product database;
query, with a group-based matching engine in real-time with the receipt of the product information at the product entry time, the borrower database to determine a subset of the plurality of borrower data sets with the one or more predefined borrower requirements that are capable of being fulfilled by the financial product;
classify, with a classification engine, the subset of the plurality of borrower data sets into a plurality of groups based on a plurality of financial product attributes;
for each of the plurality of groups, determine, via a probabilistic engine, a corresponding candidate group that has a probabilistic score that meets a probabilistic threshold indicative of a likelihood of members of the candidate group purchasing the financial product;
for each of the plurality of groups, determine, via a group discount engine that communicates with one or more lender computing systems through the computerized network, a group quantity discount to be applied to the financial product based on a predetermined group quantity threshold specific to each of the plurality of groups being met.

13. The computer program product of claim 12, wherein the probabilistic engine determines the probabilistic score, via an artificial intelligence engine, according to one or more configurable weighted attributes.

14. The computer program product of claim 13, wherein the probabilistic engine retrains the artificial intelligence engine to update the configurable weighted attributes subsequent to each candidate group being determined.

15. The computer program product of claim 12, wherein the plurality of groups consists of: a loan amount group, a credit score group, and a loan to value group.

16. The computer program product of claim 12, wherein the computer is further caused to transmit a predetermined classification and a predetermined group quantity to the one or more lender computing systems prior to the querying.

17. The computer program product of claim 16, wherein the computer is further caused to receive the predetermined group quantity threshold from the one or more lender computing systems based upon a calculation of that uses the predetermined classification and the predetermined group quantity.

18. The computer program product of claim 17, wherein the calculation automatically determines a profit margin to be realized via application of the group quantity discount in comparison to a profit margin to be realized for individualized sales of the financial product.

19. The computer program product of claim 18, further comprising performing the calculation.

19. The computer program product of claim 18, wherein the one or more lender computing systems perform the calculation.

20. The computer program product of claim 18, further comprising automatically performing a self-executing, iterative negotiation between with the one or more lender computing systems until the group quantity discount threshold is within a predetermined tolerance.
